(19) United States
(12) Patent Application Publication
(10) Pub. No.: US 2023/0112428 A1
(43) Pub. Date: Apr. 13, 2023

(54) OPTICAL FIBER CABLE THAT PROVIDES ENHANCED SEALING AND SELECTIVELY TEARS SO AS TO PROVIDE ENHANCED ACCESS TO AN OPTICAL FIBER

(71) Applicant: PPC BROADBAND FIBER LTD., Framlingham (GB)

(72) Inventors: Daniel JENKINS, Framlingham (GB); Kim LEESON, Ipswich (GB); Shaun TREZISE, Aldeburgh (GB)

(73) Assignee: PPC BROADBAND FIBER LTD., Framlingham (GB)

(21) Appl. No.: 17/963,943

(22) Filed: Oct. 11, 2022

Related U.S. Application Data
(60) Provisional application No. 63/254,244, filed on Oct. 11, 2021.

(51) Int. Cl. G02B 6/44

(52) U.S. Cl. CPC G02B 6/4495; G02B 6/447; G02B 6/443

(57) ABSTRACT

An optical fiber cable for providing enhanced sealing and enhanced access to an optical fiber for field terminations and/or splicing includes a jacket including a cavity extending along a length of the jacket and an optical fiber that is located in the cavity and extends the length of the jacket. The cavity is configured to have a length in a first direction that is greater than a width in a second direction that is perpendicular to the first direction. The jacket is configured to include a selectively teared portion that is located between the cavity and an outer surface of the jacket in the first direction such that the jacket is configured to tear along the length of the jacket at the selectively teared portion so as to allow for enhanced access to the optical fiber in the cavity, and the selectively teared portion created by the cavity is configured to permit the outer surface of the jacket to include a surface portion adjacent the selectively teared portion that is configured to provide enhanced sealing during operation of the optical fiber cable.

### CROSS-REFERENCE TO RELATED APPLICATION

This application claims the benefit of U.S. Provisional Application No. 63/254,244, filed Oct. 11, 2021, the disclosure of which is hereby incorporated by reference herein in its entirety.

### TECHNICAL FIELD

The disclosure relates to an optical fiber cable and, more particularly, to a fiber optic cable having a jacket that is configured to provide enhanced sealing during operation of the cable and provide enhanced access to the optical fiber of the cable so as to facilitate field terminations and/or splicing of the optical fiber, such as by configuring the jacket to tear along the length of the jacket at certain weakened portions.

### BACKGROUND

Broadband network architecture may use optical fiber cables to provide all or part of the local loop used for last mile telecommunications. These optical fiber cables—also known as “drop cables”—should provide good protection to optical fibers while allowing an easy access thereto; they should be suitable for being directly buried into the ground, or installed in a duct, either by pulling, pushing, or blowing, or for aerial installation.

Some conventional optical cable includes a cylindrical support that is hollowed out to form a longitudinal cavity in which one or more optical fibers are loosely accommodated. The cable comprises of one or more strain bearing elements embedded in the cylindrical support, provided longitudinally and symmetrically with respect to the cable axis. The longitudinal cavity may be radially extended between the couple of bearing elements and the plane comprising the couple of strain bearing elements transverses the slot. The support is made of a thermoplastic material, for example polyethylene. The couple of bearing elements are made, for example, of glass fiber, aramid fiber or carbon fiber. Such conventional cables are difficult to tear along their longitudinal length.

Some conventional optical cable, such as the CasaLink Block Terminal (“CBT”) Drop cable of the Prysmian Group illustrated in FIG. 8, includes a notched outer surface to assist with tearing of the cable along its length. However, such a notched cable poses a problem when attempting to provide a weatherproof seal around the cable. For example, the optical cable is typically terminated or spliced at an enclosure box and/or with a connector. The notched (i.e., non-circular) cable does not provide a circular outer surface for sealing at a port of an enclosure box or at a connector. Particularly, a gland or grommet of an enclosure box or a boot or O-ring of a connector may not be able to provide a weathertight seal against such a non-circular outer surface of the notched cable.

It may be desirable to provide a fiber optic cable having a jacket configured to include one or more selectively teared or weakened portions or configurations such that the jacket is configured to selectively tear along the length of the jacket at such selectively teared portions so as to selectively expose the optical fiber in the cavity and thus provide enhanced sealing during operation and enhanced access to the optical fiber to better facilitate field terminations and/or splicing. It may be desirable to provide the jacket with a cavity along the length of the cable that provides the selectively teared portions. It also may be desirable to embed one or more strengthening members or portions in the jacket proximate or spaced away from the selectively teared portions. It further may be desirable to provide one or more enhanced access indicator portions on the outer surface of the jacket to identify the selectively teared portions.

### SUMMARY

In accordance with various exemplary embodiments of the disclosure, an optical fiber cable for providing enhanced sealing during operation and for providing enhanced access to an optical fiber to better facilitate field terminations and/or splicing of the optical fiber may include a hollow jacket that includes a cavity having an oblong shape in a cross section of the hollow jacket that extends along a length of the hollow jacket, an optical fiber that is located in the cavity and extends the length of the hollow jacket, and a strengthening member embedded in the hollow jacket. The cavity is configured to have a cavity length in a first direction transverse to the length of the hollow jacket that is greater than a maximum cavity width in a second direction that is perpendicular to the first direction and transverse to the length of the hollow jacket, and the cavity includes a first end and a second end in the first direction along a first axis. An outer surface of the hollow jacket is configured to include an indicator portion aligned with the first end and the second end in the first direction along the first axis. The hollow jacket is configured to include first portions between the first end of the cavity and the outer surface of the jacket and between the second end of the cavity and the outer surface of the jacket in the first direction along the first axis, and a center of the cavity in the first direction has a largest width in the second direction extending from a first side of the cavity to a second side of the cavity along a second axis in the second direction. The hollow jacket is configured to include second portions between the first side of the cavity and the outer surface of the hollow jacket and between the second side of the cavity and the outer surface of the hollow jacket in the second direction along the second axis, and the strengthening member is located in one of the second portions between the cavity and the outer surface of the hollow jacket in the second direction along the width axis. Each of the first portions is configured to include a first thickness, each of the second portions is configured to include a second thickness, and the second thickness is greater than the first thickness. The thinner first portions are weaker than the thicker second portions such that the hollow jacket is configured to tear along the length of the jacket at the first portions so as to provide enhanced access to the optical fiber in the cavity, and the thinner first portions created by the oblong cavity are configured to permit the outer surface of the jacket to include a continuously circular, curved, or arcuate outer surface portion that is configured to provide enhanced sealing during operation of the optical cable.

According to various aspects of the above embodiment, the optical cable further comprises a water swellable material portion that is located in the cavity.

According to various aspects of the above embodiments of the optical cable, the strengthening member comprises twisted strands of brass plated steel.

According to various aspects of the above embodiments, the cable further comprises a rip cord in the cavity that is configured to assist with tearing of the jacket at the first portions.

According to various aspects of the above embodiments of the optical cable, the indicator portion comprises a color portion of the outer surface of the hollow jacket that contrasts with a remainder of the outer surface of the hollow jacket.

According to various exemplary embodiments of the disclosure, an optical fiber cable for providing enhanced sealing during operation and selectively teared access to an optical fiber so as to facilitate field terminations and/or splicing of the optical fiber cable includes a jacket including a cavity having an oblong shape in a cross section of the jacket and extending along a length of the jacket and an optical fiber that is located in the cavity and extends the length of the jacket. The cavity is configured to have a length in a first direction that is greater than a width in a second direction that is perpendicular to the first direction, and the cavity includes a first end and a second end in the first direction along a first axis. An outer surface of the jacket includes an indicator portion aligned with the first end and the second end in the first direction along the first axis, the jacket is configured to include first portions between the first end of the cavity and the outer surface of the jacket and between the second end of the cavity and the outer surface of the jacket in the first direction along the first axis, and the jacket is configured to include second portions between a first side of the cavity and the outer surface of the jacket and between a second side of the cavity and the outer surface of the jacket in a second direction along a second axis that is perpendicular to the first axis. The first portions are configured to be weaker than the second portions such that the jacket is configured to tear along the length of the jacket at the first portions, thereby exposing the optical fiber in the cavity, and the first portions created by the oblong shape of the cavity are configured to permit the outer surface of the jacket to include a curved or arcuate outer surface portion adjacent the first portions that is configured to provide enhanced sealing of the optical fiber cable during operation.

According to various aspects of the above embodiments of the optical cable, a center of the cavity in the first direction has a largest width in the second direction extending from a first side of the cavity to a second side of the cavity along a second axis.

According to various aspects of the above embodiments of the optical cable, each of the first portions is configured to include a first thickness and each of the second portions is configured to include a second thickness, and the second thickness is greater than the first thickness.

According to various aspects of the above embodiments, the optical cable further comprises a strengthening member embedded in one of the second portions between the cavity and the outer surface of the hollow jacket in the second direction along the width axis.

According to various aspects of the above embodiments of the optical cable, the strengthening member comprises twisted strands of brass plated steel.

According to various aspects of the above embodiments, the optical cable further comprises a rip cord located in the cavity and configured to assist with tearing of the jacket at the first portions.

According to various aspects of the above embodiments of the optical cable, the indicator portion comprises a color portion of the outer surface of the jacket that contrasts with a remainder of the outer surface of the jacket.

According to various aspects of the above embodiments, the optical cable further comprises a water swellable material portion that is located in the cavity.

According to various aspects of the above embodiments, the curved outer surface portion comprises a continuously curved or arcuate outer surface portion.

In accordance with various exemplary embodiments of the disclosure, an optical fiber cable for providing enhanced sealing and enhanced access to an optical fiber for field terminations and/or splicing includes a jacket including a cavity extending along a length of the jacket and an optical fiber that is located in the cavity and extends the length of the jacket. The cavity is configured to have a length in a first direction that is greater than a width in a second direction that is perpendicular to the first direction. The jacket is configured to include a selectively teared portion that is located between the cavity and an outer surface of the jacket in the first direction such that the jacket is configured to tear along the length of the jacket at the selectively teared portion so as to allow for enhanced access to the optical fiber in the cavity, and the selectively teared portion created by the cavity is configured to permit the outer surface of the jacket to include a surface portion adjacent the selectively teared portion that is configured to provide enhanced sealing during operation of the optical fiber cable.

According to various aspects of the above embodiment of the optical cable, the cavity includes a first end and a second end in the first direction along a first axis and a first side and a second side in the second direction along a second axis.

According to various aspects of the above embodiments of the optical cable, the selectively teared portion comprises first portions between the first end of the cavity and the outer surface of the jacket and between the second end of the cavity and the outer surface of the jacket in the first direction along the first axis.

According to various aspects of the above embodiments of the optical cable, the jacket is configured to include second portions between the first side of the cavity and the outer surface of the jacket and between the second side of the cavity and the outer surface of the jacket in the second direction along the second axis, wherein the weakened portions are configured to be weaker than the second portions.

According to various aspects of the above embodiments of the optical cable, an outer surface of the jacket includes an indicator portion aligned with the first end and the second end in the first direction along the first axis.

According to various aspects of the above embodiments of the optical cable, a center of the cavity in the first direction has a largest width in the second direction extending from a first side of the cavity to a second side of the cavity along a second axis.

According to various aspects of the above embodiments of the optical cable, each of the first portions is configured to include a first thickness, each of the second portions is configured to include a second thickness, and the second thickness is greater than the first thickness.

According to various aspects of the above embodiments, the optical cable further comprises a strengthening member portion embedded in the jacket between the cavity and the outer surface of the hollow jacket in the second direction.

According to various aspects of the above embodiments of the optical cable, the strengthening member portion comprises twisted strands of brass plated steel.

According to various aspects of the above embodiments, the optical cable further comprises a rip cord that is located in the cavity and is configured to assist with tearing of the jacket at the first portions.

According to various aspects of the above embodiments of the optical cable, the indicator portion comprises a color portion of the outer surface of the jacket that contrasts with a remainder of the outer surface of the jacket.

According to various aspects of the above embodiments, the optical cable further comprises a water swellable material portion that is located in the cavity.

According to various aspects of the above embodiments, the surface portion comprises a continuously curved or arcuate outer surface portion.

In accordance with various exemplary embodiments of the disclosure, an optical fiber cable for providing notchless cable sealing and selectively teared access to optical fiber of the cable for fiber termination or splicing includes a selectively teared access portion that is configured to be selectively torn into a torn state, where access to optical fiber of the cable is provided for fiber termination or splicing. The selectively teared access portion is configured to allow a notchless cable sealing portion to form a seal around the cable with a sealing member when the selectively teared portion is in an untorn state, where access to the optical fiber of the cable is not provided for fiber termination or splicing. The notchless cable sealing portion is shaped to sealingly fit the sealing member so as to form the seal around the cable with the sealing member when the selectively teared portion is in the untorn state.

In accordance with various exemplary embodiments of the disclosure, an optical fiber cable for providing notchless cable sealing and selectively teared access to optical fiber of the cable for fiber termination or splicing includes a selectively teared access portion that is configured to be selectively torn into a torn state, where access to optical fiber of the cable is provided for fiber termination or splicing. The selectively teared access portion comprises a notchless cable sealing portion that is configured to form a seal around the cable with a sealing member when the selectively teared portion is in an untorn state, where access to the optical fiber of the cable is not provided for fiber termination or splicing. The notchless cable sealing portion is shaped to sealingly fit the sealing member so as to form the seal around the cable with the sealing member when the selectively teared portion is in the untorn state.

### BRIEF DESCRIPTION OF THE DRAWINGS

Further advantages and features of the present disclosure will become apparent from the following description and the accompanying drawings, to which reference is made. In which are shown:

FIG. 1 is a cross-sectional view of an exemplary optical fiber cable in accordance with various aspects of the disclosure.

FIG. 2A is an axonometric view of the optical fiber cable in FIG. 1.

FIG. 2B is an isometric view of the optical fiber cable in FIG. 1 after the cable has been split.

FIG. 3A is a cross-sectional view of a second example cable of the present disclosure wherein the cable includes one ribbon of optical fibers.

FIG. 3B is a cross-sectional view of a third example cable of the present disclosure wherein the cable includes two ribbons of optical fibers.

FIG. 4 is a cross-sectional view of a fourth example optical fiber cable of the present disclosure where the cable includes three independent fibers.

FIG. 5 is a cross-sectional view of a fifth example optical fiber cable of the present disclosure where the cable includes bundled fibers in four loose tubes.

FIG. 6 is a cross-sectional view of a sixth example optical fiber cable of the present disclosure where the cable defines a figure of 8 cross section.

FIG. 7 is a perspective view of an example cable installed on a telephone pole.

FIG. 8 is cross-sectional view of a conventional optical fiber cable.

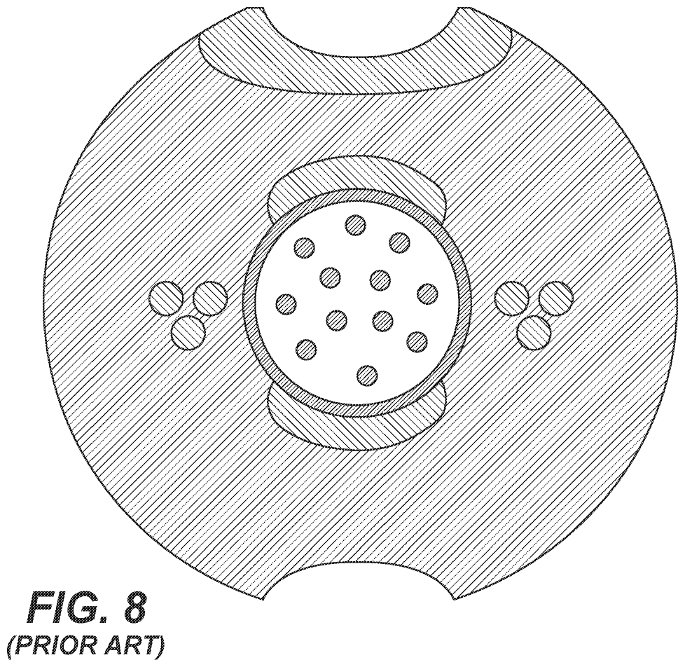

### DETAILED DESCRIPTION

Reference will now be made in detail to presently preferred embodiments and methods of the present disclosure, which constitute the best modes of practicing the present disclosure presently known to the inventors. However, it is to be understood that the disclosed embodiments are merely exemplary of the present disclosure that may be embodied in various and alternative forms. Therefore, specific details disclosed herein are not to be interpreted as limiting, but merely as a representative basis for any aspect of the present disclosure and/or as a representative basis for teaching one skilled in the art to variously employ the present disclosure.

It is also to be understood that this disclosure is not limited to the specific embodiments and methods described below, as specific components and/or conditions may, of course, vary. Furthermore, the terminology used herein is used only for the purpose of describing particular embodiments of the present disclosure and is not intended to be limiting in any way.

It must also be noted that, as used in the specification and the appended claims, the singular form “a,” “an,” and “the” comprise plural referents unless the context clearly indicates otherwise. For example, reference to a component in the singular is intended to comprise a plurality of components.

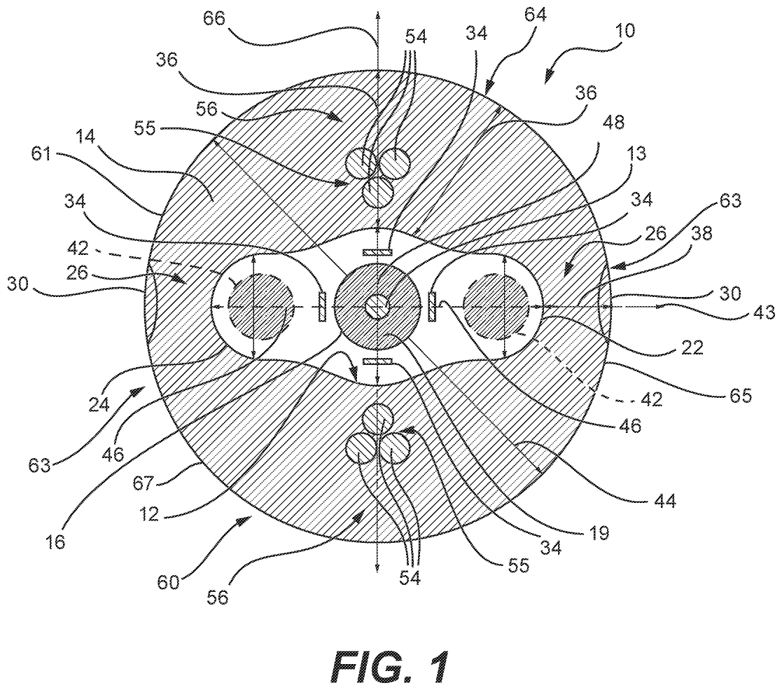

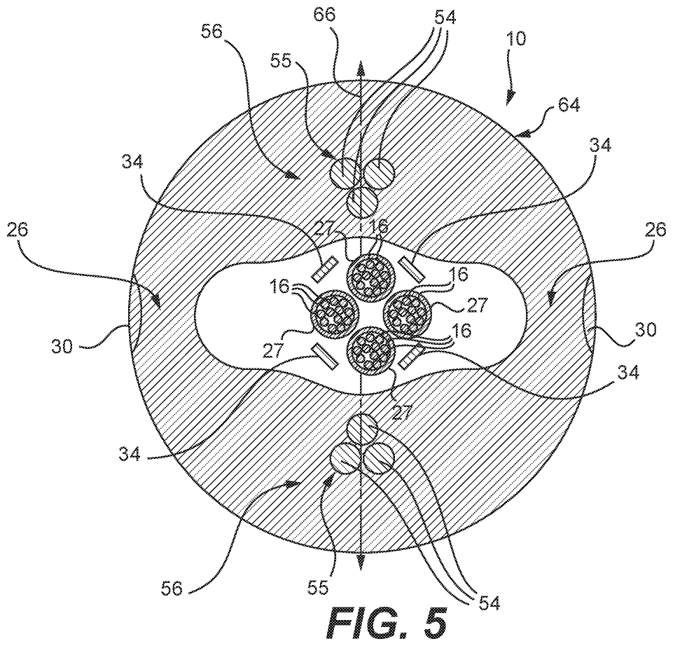

FIGS. 1-5 illustrate exemplary optical fiber cables according to various aspects of the disclosure. Referring to FIG. 1, an exemplary cable 10 includes a jacket 14, for example, a hollow jacket, that includes a cavity 12, or chamber, extending the length of the jacket 14. The cavity 12 is configured to house one or more optical fibers 16 in the loose tube. In some aspects, the cavity 12 may optionally house one or more ripcords 42. In order to avoid longitudinal water propagation, the cavity 12 of the cable 10 may contain water swellable material 18 such as, for example, a water blocking yarn or tape. As shown in FIGS. 1-5, the water swellable material 18 may be housed in the cavity 12 together with the optical fiber 16, for example, in radially external position with respect to the fiber 16.

As shown in FIG. 1, when viewed in cross-section, the cavity 12 has an oblong shape that is elongated in a first direction. The cavity 12 has a cavity length 46 in the first direction that is greater than a maximum cavity width 48 in a second direction that is perpendicular to the first direction.

The cable 10 includes an outer surface 60 or portion thereof that may include a cable sealing surface 61 or portion thereof, for example, an outer cable sealing surface or portion thereof, that is shaped to form a seal with a sealing structure or member, such as in the form of a grommet, gland, O-ring, or other sealing structure or member at an enclosure box, a connector that terminates the cable, or the like. In the illustrated embodiment, the outer surface 60 comprises an outer surface 64 of the jacket 14. In some aspects, the outer surface 60 or portion of the cable may not be the jacket 14. The outer surface 64 of the jacket 14 may include a jacket sealing surface 63 or portion thereof that is shaped to form a seal with a sealing structure or member, such as in the form of a grommet, gland, O-ring, or other sealing structure or member at an enclosure box. For instance, the jacket sealing surface 63 or portion thereof (or the cable sealing surface 61 or portion thereof, or an outer cable sealing surface or portion thereof) may be shaped as a smooth or un-notched surface or portion thereof so as to form a seal with an inner surface or portion of such a sealing structure or member. Alternatively, the jacket sealing surface 63 or portion thereof (a cable sealing surface or portion thereof, or an outer cable sealing surface or portion thereof) may include a continuously circular or curved surface 67 or portion thereof that forms a seal with the sealing member or structure.

The cavity 12 includes a first end 22 and a second end 24 in the first direction, that is, the length direction, along a length axis 43. The outer surface 64 of the jacket 14 includes indicators 30, or indicator portions, aligned with the first end 22 and the second end 24 in the first direction along the length axis 43. For example, the indicators 30 may be diametrically opposed to one another at the outer surface 64 of the jacket 14. The indicators 30 thus identify a directional location of the first end 22, the second end 24, and the first portions 26. As shown, the jacket 14 includes first portions 26 that are between the first end 22 of the cavity 12 and one of the indicators 30 and between the second end 24 of the cavity 12 and the other one of the indicators 30 in the first direction along the length axis 43.

In some aspects, the indicators 30 may comprise a color that contrasts with a color of the remainder of the outer surface 64 of the jacket 14. For example, the indicators 30 may be a bright yellow color while the remainder of the outer surface 64 of the jacket 14 is black. In some aspects, the jacket 14 and the indicators 30 may comprise coextruded polymeric materials, such as, for example, polyethylene. The polymeric material of the indicators 30 may be dyed or colored to provide the contrasting color between the indicators 30 and the outer surface 64 of the jacket 14. The jacket 14 and/or the indicators 30 may, but not necessarily, comprise High-Density Polyethylene (HDPE) or Medium Density Polyethylene (MDPE) or another polymer material such as a fiber reinforced composite material or PVC. The jacket 14 may be produced via an extrusion process, by UV curing and/or any other known technique. The extrusion manufacturing process results in a product having consistent dimensions.

As shown in FIG. 1, a center 25 of the cavity 12 in the first direction has the largest width in the second direction extending from a first side 32 of the cavity 12 to a second side 34 of the cavity 12 along a width axis 66. The jacket 14 includes second portions 56 between the first side 32 of the cavity 12 and the outer surface 64 of the jacket 14 and between the second side 34 of the cavity 12 and the outer surface 64 of the jacket 14 in the second direction along the width axis 66. In various aspects, strengthening members 55 may be embedded in the jacket 14. The strengthening members 55 may be in the second portions 56 between the cavity 12 and the outer surface 64 of the jacket in the second direction along the width axis 66. The strengthening members 55 may be embedded in the jacket 14 during the extrusion process. As shown in FIG. 1, in some aspects, the strengthening members 55 may comprise three twisted strands 54 of brass-plated steel. In some aspects, the strengthening members 55 may comprise more or less than three strands and may comprise metal or a non-metallic material. For example, in some aspects, the strengthening members 55 may comprise a single strand of fiber reinforced polymer.

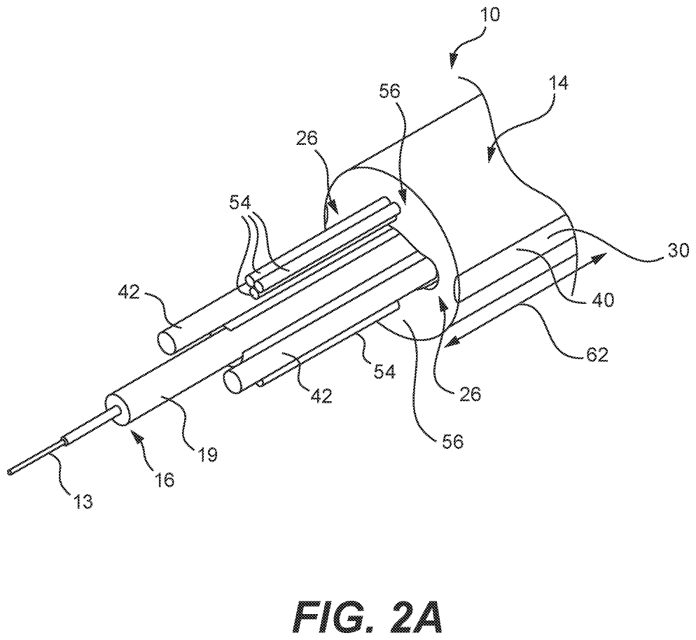

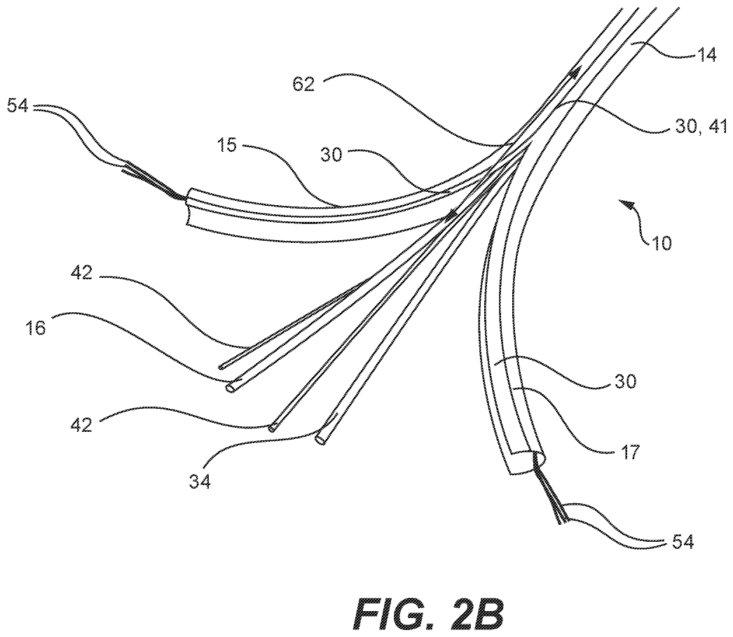

Each of the first portions 26 includes a first portion thickness 38, and each of the second portions 56 includes a second portion thickness 36. The second portion thickness 36 is greater than the first portion thickness 38 as further described herein. Thus, the thinner first portions 26 are weaker relative to the thicker second portions 56. Consequently, the first portions 26 may comprise weakened or selectively teared portions that are configured to tear along the longitudinal direction 62 (see FIG. 2B) of the cable 10 so that the jacket 14 splits open in two parts 15, 17 thereby exposing the optical fiber 16 so that a user or technician can couple the optical fiber 16 of the cable 10 with a network (not shown) or another cable (not shown). In some applications, the technician may need to terminate the fiber with a connector in preparation for coupling with the network or other cable.

By shaping the cavity 12 to provide the weakened or selectively teared first portions 26 of the jacket, instead of notching or otherwise modifying an outer surface of a jacket to provide a weakened portion, the outer surface 64 can include curved or arcuate outer surface portions 65 adjacent the first portions 26, or selectively teared portions. For example, the curved or arcuate outer surface portions 65 may be continuously curved or arcuate without a notch or other surface feature that may otherwise be used to provide a weakened portion of the jacket 12. In some aspects, the outer surface portions 65 and the outer surface 64 may comprise a continuous circle or oval. Thus, the continuously curved outer surface 64 can provide enhanced weathertight sealing of the jacket 14 at a gland or grommet of an enclosure box or at a boot or O-ring of a connector that terminates the cable. That is, the shape of the cavity 12 is configured to define the first portions 26 that permit selective tearing while permitting the curved or arcuate outer surface portions 65 to provide a surface that does not include a notch, a cutout, or discontinuity, and thus can be sealed with a grommet, gland, boot, or O-ring to provide enhanced weathertight sealing of the cable 10 at a gland or grommet of an enclosure box or at boot or O-ring of a connector that terminates the cable 10.

As previously indicated, the cavity 12 may be configured to house one or more optional ripcords 42. In some aspects, the ripcords 42 may facilitate, or assist with, the separation of the jacket 14 along the longitudinal direction into two parts 15, 17 when the ripcords 42 are pulled in opposite directions away from one another by a user or technician in a direction of the length axis 43 toward the respective first portions 26 of the jacket 14. As shown in FIG. 1, the optional ripcords 42 may be disposed on each lateral side of the optical fiber 16 wherein each ripcord 42 is adjacent to a corresponding first portion 26. However, it should be appreciated that because the cavity 12 is a loose tube, the relative positions between the optional ripcords 42, the optical fiber 16, and/or the water blocking material 18 may shift during manufacturing, transportation, storage, and/or use.

In the exemplary embodiment of FIG. 1, an exemplary optical fiber 16 may have a width of about 0.250 mm for the primary coated fiber 13 with about 600-900 microns (e.g., 0.650 mm) of standard secondary coating 19 for the primary coated fiber 13. Therefore, in the example provided, the primary coated fiber 13 and the secondary coating 19 may have a total diameter of about 900 microns or 0.9 mm. However, it is understood that the primary optical coated fiber 13 has a diameter (without the secondary coating) that could vary from 0.25 mm to 0.5 mm.

An exemplary jacket 14 consistent with the exemplary embodiment of FIG. 1 may have a diameter 44 of about 4.9 mm, and the cavity defined in the jacket may have a length 46 of about 3.4 mm and a height 48 of about 3.28 mm. An exemplary combined length 38 of a first portion 26 and indicator 30 along the length axis 43 may be about 0.75 mm. An exemplary width 36 of a second portion along the width axis 66 is about 1.63 mm. Therefore, in the present example, a ratio of the width 36 of the second portion 56 to the length 38 of the first portion 26 is about 2.17. It should be understood that the combined length 38 of the first portion 26 and indicator 30 may fall within a range of about 0.5 mm to about 1.0 mm. Thus, it should be understood that the ratio of the width 36 of the second portion 56 to the length 38 of the first portion 26 may fall in the range of 1.5 to 3.3.

With respect to an aerial installation, the aforementioned exemplary range of 1.5 to 3.3 for the ratio of the width 36 of the second portion 56 to the length 38 of the first portion 26 optimizes the elongation of the cable 10 and optimizes tearing of the jacket in the first portions 26 when installed at a determinate span under wind and ice loads while also maintaining cable strength. Furthermore, the dimensional proportions enable a user to easily access the cavity 12 defined in the jacket 14. As indicated, the first portions 26 are configured to tear along the longitudinal direction 62 of the cable 10 so that the jacket 14 splits open in two parts 15, 17, as shown in FIG. 2B, thereby exposing the optical fiber 16 so that a user or technician can access the optical fiber 16 of the cable 10 to couple the optical fiber 16 to a network (not shown) or another cable (not shown).

Referring to FIG. 2B, it is understood that the cable 10 may be split at the first portions 26 by cutting into such first portions 26, for example, by cutting into the indicator portions 30 that are aligned with the first portions 26. The cuts may be made with a knife or any cutting or scoring tool. After the cuts are made, a technician or user can split the cable 10 so that the jacket 14 is separated in two parts 15, 17, as previously described. For example, the cable 10 can be split along its length by pulling the two parts 15, 17 of the jacket 14 by hand or will a gripping tool. The new joint (not shown) between the exposed optical fiber 16 and the network (not shown) or other cable (not shown) may be created in the middle of the cable 10 (mid-span) or at the end of the cable 10—since the initial cuts are made at the indicator portions 30 and/or first portions 26 of the cable 10.

With respect to the strengthening members 54, the cable 10 is configured to flex or bend along the width axis 66, which enables the cable 10 to be wound about a spool (not shown) before the cable is installed. As noted, the strengthening members 54 may be longitudinal wires which may be metallic such as brass plated metal or may be a glass reinforced plastic (GRP) or fiber reinforced plastic (FRP). GRP and FRP strengthening members 54 may be preferred when the cable 10 is implemented in proximity to high power lines, and there is a desire to prevent the high power from interfering with the customer network via the cable 10.

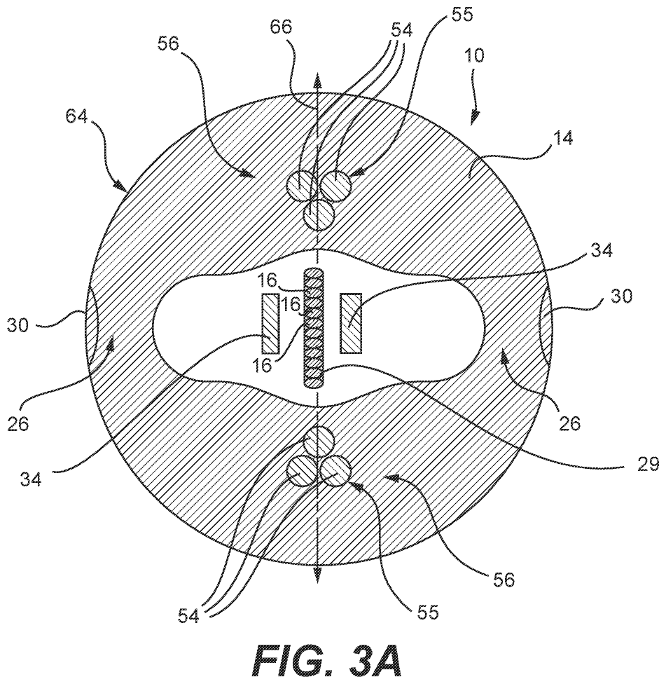

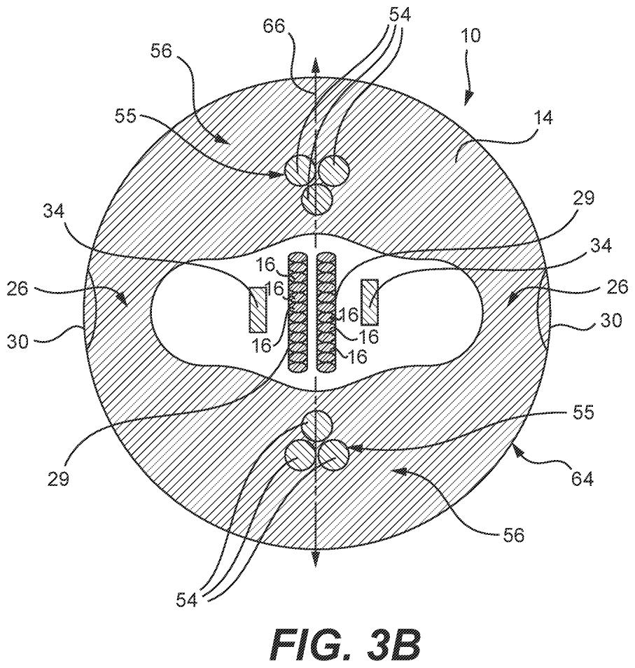

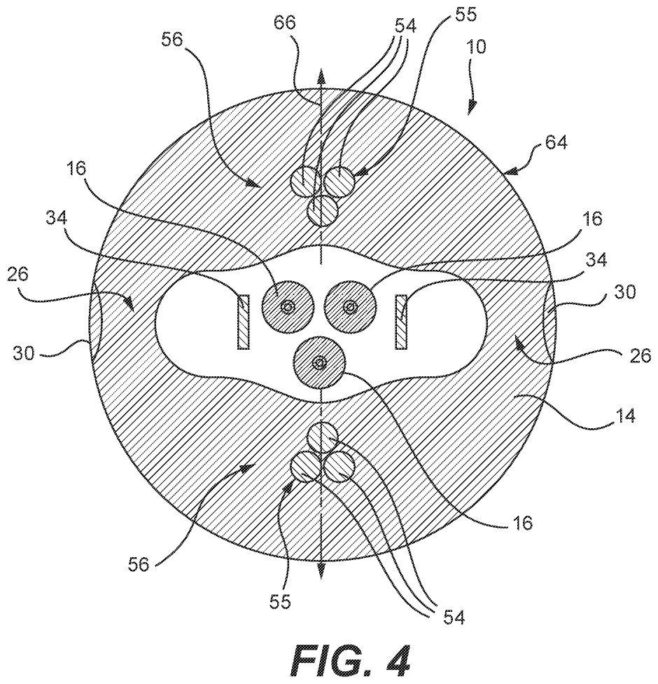

In the exemplary embodiment of FIG. 1, one single optical fiber 16 is housed in the cavity 12 of in the jacket 14. However, in other embodiments, a plurality of optical fibers 16 can be housed in the cavity 12. For example, as shown in FIGS. 3A-5, other exemplary embodiments consistent with the disclosure may include a plurality of optical fibers 16. In the exemplary embodiment shown in FIGS. 3A and 3B, the cable 10 may include a plurality of fibers 16 in a ribbon 29 arranged in a stacked configuration. It should be understood that, in some aspects, the ribbon 29 may be a rollable ribbon such that the fibers 16 can be arranged in a bundled configuration. As shown in FIG. 4, an exemplary embodiment of the cable 10 may include a plurality of individual optical fibers 16 loosely arranged in the cavity 12. As shown FIG. 4, an exemplary embodiment of the cable 10 may include a plurality of fiber 16 bundled in loose tubes 27 or in UV-cured resin bundles (not shown) that are loosely arranged in the cavity 12.

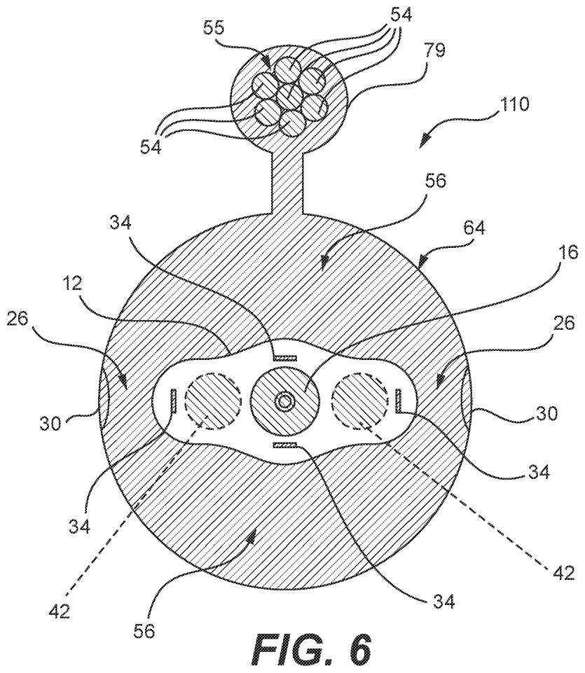

As shown in FIG. 1, the jacket 14 may have a substantially circular cross-section, wherein the jacket 14 defines the oblong cavity 12. However, the jacket 14 can have a cross-section different from the circular cross-section shown, for instance the jacket may be oval, dual-bulbed (“figure of 8”) cross-section (FIG. 6), or rectangular. With respect to a hollow jacket which has a “figure of 8” (dual bulb) cross-section, it is understood that strengthening members 54 may be embedded in an upper portion 79, or messengered portion, of the cable 110 during the extrusion process, as illustrated in FIG. 6.

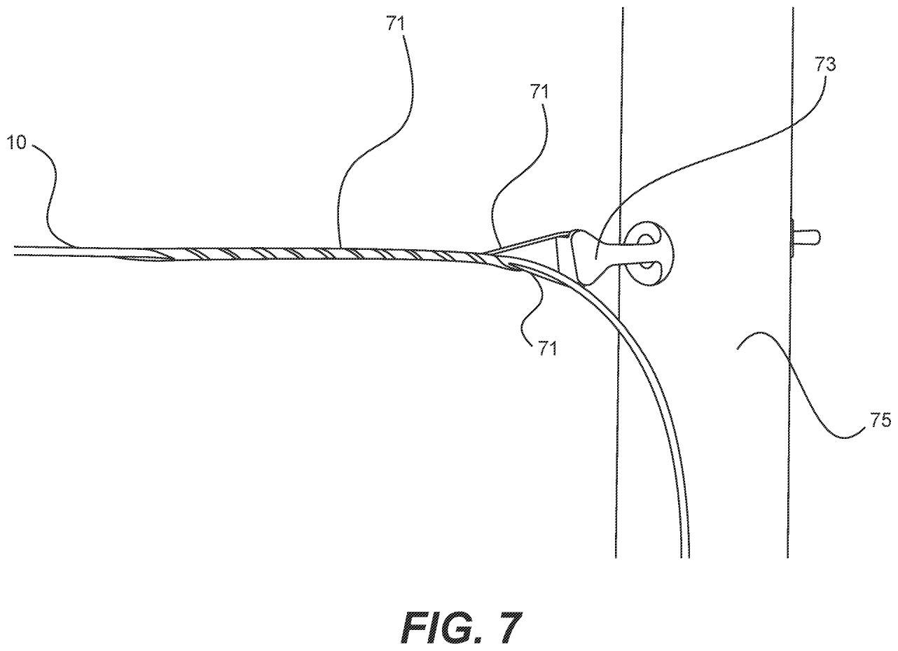

Referring to FIG. 7, with a cable 10 having a jacket 14 that is substantially circular in cross section, as shown in own in FIG. 1, pre-formed helical attachment tensile stoppers 71 and/or anchoring members 73 may be used to pull the cable 10 into a duct (not shown) or suspend the cable 10 from a telephone pole 75 or buildings. The pre-formed attachment tensile stoppers 71 may be implemented during the installation process and are used to anchor the cable 10 to specific locations.

These aforementioned configurations have a number of advantages, including an easy management (for instance easy coiling) of the cable during manufacturing thereof or an easy positioning of dead-end clamps. Further or different indicia could be provided for locating the opening of the cavity (via the minor portions) from the outer surface of the sheath, such as an indentation or an ink line 41 (see FIG. 2B) (vs. a co-extruded polymeric filler material).

While example, non-limiting embodiments have been presented in the foregoing detailed description, it should be appreciated that a vast number of variations exist. It should also be appreciated that the exemplary embodiment or exemplary embodiments are only examples, and are not intended to limit the scope, applicability, or configuration of the disclosure in any way. Rather, the foregoing detailed description will provide those skilled in the art with a convenient road map for implementing the exemplary embodiment or exemplary embodiments. It should be understood that various changes can be made in the function and arrangement of elements without departing from the scope of the disclosure as set forth in the appended claims and the legal equivalents thereof.

What is claimed is:

1. An optical fiber cable for providing enhanced sealing during operation and for providing enhanced access to an optical fiber to better facilitate field terminations and/or splicing of the optical fiber, comprising:
a hollow jacket that includes a cavity having an oblong shape in a cross section of the hollow jacket that extends along a length of the hollow jacket;
an optical fiber that is located in the cavity and extends the length of the hollow jacket;
a strengthening member embedded in the hollow jacket;
wherein the cavity is configured to have a cavity length in a first direction transverse to the length of the hollow jacket that is greater than a maximum cavity width in a second direction that is perpendicular to the first direction and transverse to the length of the hollow jacket;
wherein the cavity includes a first end and a second end in the first direction along a first axis;
wherein an outer surface of the hollow jacket is configured to include an indicator portion aligned with the first end and the second end in the first direction along the first axis;
wherein the hollow jacket is configured to include first portions between the first end of the cavity and the outer surface of the hollow jacket and between the second end of the cavity and the outer surface of the hollow jacket in the first direction along the first axis;
wherein a center of the cavity in the first direction has a largest width in the second direction extending from a first side of the cavity to a second side of the cavity along a second axis in the second direction;
wherein the hollow jacket is configured to include second portions between the first side of the cavity and the outer surface of the hollow jacket and between the second side of the cavity and the outer surface of the hollow jacket in the second direction along the second axis;
wherein the strengthening member is located in one of the second portions between the cavity and the outer surface of the hollow jacket in the second direction along the width axis;
wherein each of the first portions is configured to include a first thickness and each of the second portions is configured to include a second thickness, and the second thickness is greater than the first thickness;
wherein the thinner first portions are weaker than the thicker second portions such that the hollow jacket is configured to selectively tear along the length of the jacket at the first portions so as to provide enhanced access the optical fiber in the cavity; and
wherein the thinner first portions created by the oblong cavity are configured to permit the outer surface of the jacket to include a continuously circular, curved, or arcuate outer surface portion that is configured to provide enhanced sealing during operation of the optical cable.

2. The cable of claim 1, further comprising a water swellable material portion that is located in the cavity.

3. The cable of claim 1, wherein the strengthening member comprises twisted strands of brass plated steel.

4. The cable of claim 1, further comprising a rip cord in the cavity that is configured to assist with tearing of the hollow jacket at the first portions.

5. The cable of claim 1, wherein the indicator portion comprises a color portion of the outer surface of the hollow jacket that contrasts with a remainder of the outer surface of the hollow jacket.

6. An optical fiber cable for providing enhanced sealing during operation and selectively teared access to an optical fiber so as to facilitate field terminations and/or splicing of the optical fiber cable, comprising:
a jacket including a cavity having an oblong shape in a cross section of the jacket and extending along a length of the jacket;
an optical fiber that is located in the cavity and extends the length of the jacket;
wherein the cavity is configured to have a length in a first direction that is greater than a width in a second direction that is perpendicular to the first direction;
wherein the cavity includes a first end and a second end in the first direction along a first axis;
wherein an outer surface of the jacket includes an indicator portion aligned with the first end and the second end in the first direction along the first axis;
wherein the jacket is configured to include first portions between the first end of the cavity and the outer surface of the jacket and between the second end of the cavity and the outer surface of the jacket in the first direction along the first axis;
wherein the jacket is configured to include second portions between a first side of the cavity and the outer surface of the jacket and between a second side of the cavity and the outer surface of the jacket in a second direction along a second axis that is perpendicular to the first axis;
wherein the first portions are configured to be weaker than the second portions such that the jacket is configured to tear along the length of the jacket at the first portions, thereby exposing the optical fiber in the cavity; and
wherein the first portions created by the oblong shape of the cavity are configured to permit the outer surface of the jacket to include a curved or arcuate outer surface portion adjacent the first portions that is configured to provide enhanced sealing of the optical fiber cable during operation.

7. The cable of claim 6, wherein a center of the cavity in the first direction has a largest width in the second direction extending from a first side of the cavity to a second side of the cavity along a second axis.

8. The cable of claim 6, wherein each of the first portions is configured to include a first thickness and each of the second portions is configured to include a second thickness, and the second thickness is greater than the first thickness.

9. The cable of claim 6, further comprising a strengthening member that is embedded in one of the second portions between the cavity and the outer surface of the hollow jacket in the second direction along the width axis.

10. The cable of claim 9, wherein the strengthening member comprises twisted strands of brass plated steel.

11. The cable of claim 6, further comprising a rip cord in the cavity that is configured to assist with tearing of the jacket at the first portions.

12. The cable of claim 6, wherein the indicator portion comprises a color portion of the outer surface of the jacket that contrasts with a remainder of the outer surface of the jacket.

13. The cable of claim 6, further comprising a water swellable material portion that is located in the cavity.

14. The cable of claim 6, wherein the curved outer surface portion comprises a continuously curved or arcuate outer surface portion.

15. An optical fiber cable for providing enhanced sealing and enhanced access to an optical fiber for field terminations and/or splicing, comprising:
a jacket that include a cavity that extends along a length of the jacket;
an optical fiber that is located in the cavity and extends along the length of the jacket;
wherein the cavity is configured to have a length in a first direction that is greater than a width in a second direction that is perpendicular to the first direction;
wherein the jacket is configured to include a selectively teared portion that is located between the cavity and an outer surface of the jacket in the first direction such that the jacket is configured to tear along the length of the jacket at the selectively teared portion so as to allow for enhanced access to the optical fiber in the cavity; and
wherein the selectively teared portion created by the cavity is configured to permit the outer surface of the jacket to include a surface portion adjacent the selectively teared portion that is configured to provide enhanced sealing during operation of the optical fiber cable.

16. The cable of claim 15, wherein the cavity includes a first end and a second end in the first direction along a first axis and a first side and a second side in the second direction along a second axis.

17. The cable of claim 16, wherein the selectively teared portion comprises first portions between the first end of the cavity and the outer surface of the jacket and between the second end of the cavity and the outer surface of the jacket in the first direction along the first axis.

18. The cable of claim 16, wherein the jacket is configured to include second portions between the first side of the cavity and the outer surface of the jacket and between the second side of the cavity and the outer surface of the jacket in the second direction along the second axis, and wherein the selectively teared portion is configured to be weaker than the second portions.

19. The cable of claim 16, wherein an outer surface of the jacket includes an indicator portion that is aligned with the first end and the second end in the first direction along the first axis.

20. The cable of claim 16, wherein a center of the cavity in the first direction has a largest width in the second direction extending from a first side of the cavity to a second side of the cavity along a second axis.

21. The cable of claim 17, wherein each of the first portions is configured to include a first thickness, each of the second portions is configured to include a second thickness, and the second thickness is greater than the first thickness.

22. The cable of claim 15, further comprising a strengthening member portion that is embedded in the jacket between the cavity and the outer surface of the hollow jacket along the second direction.

23. The cable of claim 22, wherein the strengthening member portion comprises a twisted strand of brass plated steel.

24. The cable of claim 15, further comprising a rip cord that is located in the cavity and is configured to assist with tearing of the jacket at the first portions.

25. The cable of claim 19, wherein the indicator portion comprises a color portion of the outer surface of the jacket that contrasts with a remainder of the outer surface of the jacket.

26. The cable of claim 15, further comprising a water swellable material portion that is located in the cavity.

27. The cable of claim 15, wherein the surface portion comprises a continuously curved or arcuate outer surface portion.
